(19) United States
(12) Patent Application Publication
(10) Pub. No.: US 2020/0164581 A1
(43) Pub. Date: May 28, 2020

(54) THREE-DIMENSIONAL PRINTING DEVICE

(71) Applicant: Roland DG Corporation, Hamamatsu-shi (JP)

(72) Inventor: Fumiyoshi IWASE, Hamamatsu-shi (JP)

(21) Appl. No.: 16/684,823

(22) Filed: Nov. 15, 2019

(30) Foreign Application Priority Data
Nov. 22, 2018 (JP) 2018-219398

(51) Int. Cl. B29C 64/357; B33Y 30/00; B33Y 40/00; B33Y 50/02; B29C 64/393; B29C 64/255; B29C 64/245

(52) U.S. Cl. CPC B29C 64/357; B33Y 30/00; B33Y 40/00; B29C 64/245; B29C 64/393; B29C 64/255; B33Y 50/02

(57) ABSTRACT

A three-dimensional printing device includes a powder supplier that supplies a powder material, a printing tank, a layer former that flattens the powder material, supplied by the powder supplier, in the printing tank, and a powder recovery tank. The layer former moves a layer flattener at least from above the printing tank to above the powder recovery tank while keeping the layer flattener at a predetermined height above the printing tank and the powder recovery tank. The powder recovery tank includes a first cylindrical portion that is opened upward and extends in an up-down direction, a first elevatable table that is accommodated in the first cylindrical portion and is movable up and down in the first cylindrical portion, and a first elevator that supports, and moves up and down, the first elevatable table.

### CROSS REFERENCE TO RELATED APPLICATIONS

This application claims the benefit of priority to Japanese Patent Application No. 2018-219398 filed on Nov. 22, 2018. The entire contents of this application are hereby incorporated herein by reference.

### BACKGROUND OF THE INVENTION

### 1. Field of the Invention

The present invention relates to a three-dimensional printing device.

### 2. Description of the Related Art

Conventionally, a method for printing a three-dimensional printing object is known by which a curing liquid is injected into a powder material to form a thin cured layer having a desired cross-sectional shape, and such cured layers are stacked to form a three-dimensional printing object. In order to form a cured layer by such a method, a new powder layer is formed on a formed powder layer containing a cured layer. An extra portion of the powder material that is not contained in the newly stacked powder layer is recovered and reused in many cases. For example, Japanese Laid-Open Patent Publication No. 2018-126974 discloses a three-dimensional printing device including a printing tank in which a printing object is printed, a powder transfer portion that supplies a powder material to the printing tank, and a powder recovery portion that recovers the extra powder. The powder recovery portion disclosed in Japanese Laid-Open Patent Publication No. 2018-126974 is provided side by side with the printing tank and includes an internal space into which the extra powder is dropped. The internal space has a top opening. The powder transfer portion pushes the extra powder to drop the extra powder into the internal space of the powder recovery portion.

When the powder material is dropped into the powder recovery portion as disclosed in Japanese Laid-Open Patent Publication No. 2018-126974, a portion of the powder material may soar into the air and become airborne. When a large amount of the powder material soars into the air, there may be an undesirable possibility that, for example, the powder material is attached to an injection head that injects the curing liquid and prevents the injection head from injecting the curing liquid in a proper manner.

### SUMMARY OF THE INVENTION

Preferred embodiments of the present invention provide three-dimensional printing devices that prevent an extra portion of powder to be recovered from soaring into the air and become airborne.

A three-dimensional printing device disclosed herein includes a powder supplier that supplies a powder material; a printing tank in which a printing object is printed of the powder material; a layer former that flattens the powder material, supplied by the powder supplier, in the printing tank; and a powder recovery tank provided side by side with the printing tank. The layer former includes a layer flattener that contacts the powder material, and a conveyor that moves the layer flattener at least from above the printing tank to above the powder recovery tank while keeping the layer flattener at a predetermined height above the printing tank and the powder recovery tank. The powder recovery tank includes a first cylindrical portion that is opened upward and extends in an up-down direction, a first elevatable table that is accommodated in the first cylindrical portion and is movable up and down in the first cylindrical portion, and a first elevator that supports, and moves up and down, the first elevatable table.

The above-described three-dimensional printing device moves the first elevatable table, which defines a bottom portion of the powder recovery tank, up and down, and therefore, adjusts the distance by which the powder material is dropped. Even if the height by which the recovered powder material is accumulated on the first elevatable table changes moment by moment, the distance by which the powder material is dropped is adjustable in accordance with the changing height. Therefore, for example, the distance by which the powder material is dropped may be kept at a short distance at which the powder material does not soar into the air easily, so that the powder material is prevented from soaring into the air and becoming airborne. Therefore, the above-described three-dimensional printing device prevents the extra powder to be recovered from soaring into the air and become airborne.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a cross-sectional view schematically showing a three-dimensional printing device according to preferred embodiment 1 of the present invention.

FIG. 2 is a plan view schematically showing the three-dimensional printing device.

FIG. 3 is a block diagram of the three-dimensional printing device.

FIG. 4 is a vertical cross-sectional view of a printing tank unit at the time when the formation of an immediately previous cured layer is finished.

FIG. 5 is a vertical cross-sectional view of the printing tank unit at the time when a powder material is supplied from a supply tank.

FIG. 6 is a vertical cross-sectional view of the printing tank unit in a state in which the formation of a new powder layer is finished.

FIG. 7 is a vertical cross-sectional view of a printing tank unit according to preferred embodiment 2 of the present invention.

FIG. 8 is a block diagram of a three-dimensional printing device according to preferred embodiment 2 of the present invention.

### DETAILED DESCRIPTION OF THE PREFERRED EMBODIMENTS

Hereinafter, preferred embodiments of three-dimensional printing devices according to the present invention will be described with reference to the drawings. The preferred embodiments described herein are not intended to specifically limit the present invention. Components and portions that have the same functions will bear the same reference signs, and overlapping descriptions will be omitted or simplified.

### Preferred Embodiment 1

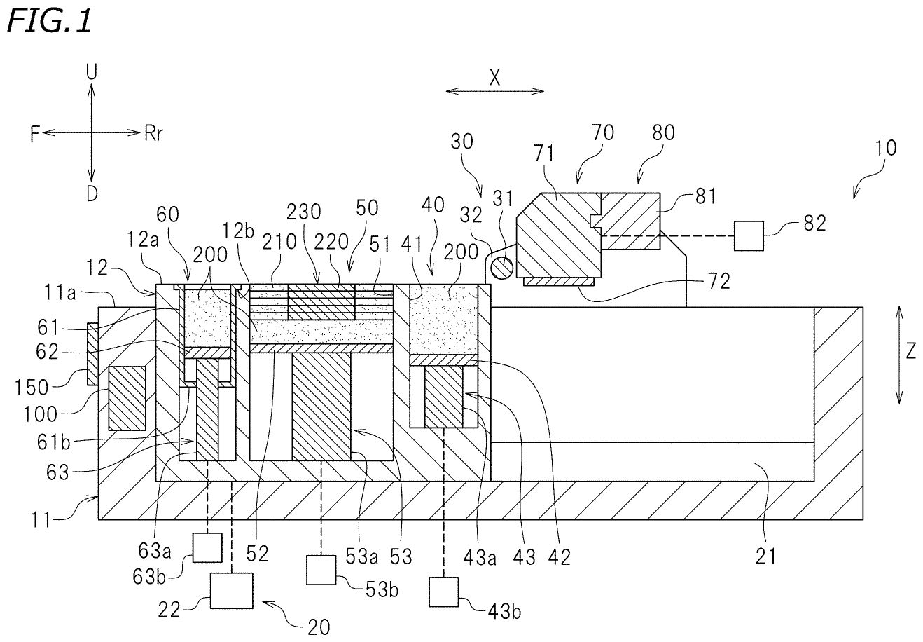

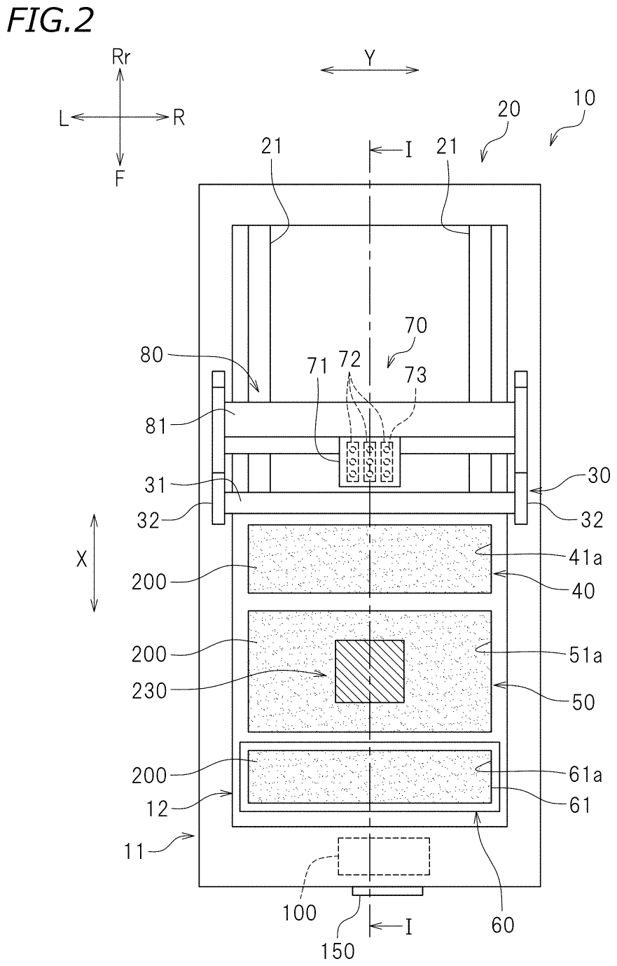

FIG. 1 is a cross-sectional view schematically showing a three-dimensional printing device 10 according to preferred embodiment 1 of the present invention. FIG. 2 is a plan view of the three-dimensional printing device 10. FIG. 1 is a cross-sectional view of the three-dimensional printing device 10 taken along line I-I in FIG. 2. In the figures, letter F represents “front”, and letter Rr represents “rear”. Referring to FIG. 2, “left”, “right”, “up” and “down” for a viewer who is looking at the three-dimensional printing device 10 from the side of letter F are respectively left, right, up and down of the three-dimensional printing device 10. In the figures, letters L, R, U and D respectively represent “left”, “right”, “up” and “down”. Letters X, Y and Z respectively represent a front-rear direction, a left-right direction, and an up-down direction. The left-right direction Y is a main scanning direction of the three-dimensional printing device 10. The front-rear direction X is a sub scanning direction of the three-dimensional printing device 10. The up-down direction Z is a stacking direction in which layers are stacked during three-dimensional printing. These directions are merely defined for the sake of convenience, and do not limit the manner of installation of the three-dimensional printing device 10 in any way.

As shown in FIG. 1, the three-dimensional printing device 10 includes a main body 11, a printing tank unit 12, a roller unit 30, a head unit 70, a sub scanning direction conveyor 20, a main scanning direction conveyor 80, and a controller 100. The printing tank unit 12 accommodates a supply tank 40, a printing tank 50 and a powder recovery tank 60. The three-dimensional printing device 10 prints a printing object 230 as follows. A powder material 200 supplied from the supply tank 40 is flattened in the printing tank 50 to form a powder layer 210. A curing liquid is injected to a desired position in the powder layer 210 and cures the powder layer 210, and thus a cured layer 220 is formed. Such cured layers 220 are stacked in an upward direction to form the printing object 230.

As shown in FIG. 2, the main body 11 is an outer casing of the three-dimensional printing device 10, and is long in the sub scanning direction X. The main body 11 has a box shape that is opened upward. The main body 11 accommodates the sub scanning direction conveyor 20, the printing tank unit 12 and the controller 100. As shown in FIG. 1, the main body 11 supports the roller unit 30 and the main scanning direction conveyor 80.

As shown in FIG. 1, the printing tank unit 12 is accommodated in the main body 11. A top surface 12a of the printing tank unit 12 is flat. The printing tank 50, the supply tank 40 and the powder recovery tank 60 are provided side by side and recessed from the top surface 12a independently.

The supply tank 40 is located in a rear portion of the printing tank unit 12. The supply tank 40 supplies the powder material 200. The supply tank 40 stores the powder material 200 before the powder material 200 is supplied to the printing tank 50. As shown in FIG. 1, the supply tank 40 includes a cylindrical portion 41 extending in the up-down direction. The cylindrical portion 41 includes an opening 41a (FIG. 2) opened upward. As shown in FIG. 2, the opening 41a is rectangular as seen in a plan view. The opening 41a is not limited to having a rectangular planar shape.

There is no specific limitation on the composition, the form or the like of the powder material 200. The powder material 200 may be made of any of various materials including a resin material, a metal material, an inorganic material and the like. Examples of the material of the powder material 200 include ceramic materials such as alumina, silica, titania, zirconia and the like; iron, aluminum, titanium and an alloy thereof (typically, stainless steel, titanium alloy, aluminum alloy); hemihydrate gypsum (α-type hemihydrate gypsum, β-type hemihydrate gypsum); apatite; salt; plastic materials; and the like. The powder material 200 may be made of one of these materials or a mixture of two or more of these materials. In the case where the powder material 200 is made of a mixture of materials, particles of different materials may have different particle diameters. For example, particles used as a binder may be finer than particles used as an aggregate.

A supply table 42 having the same shape as that of the cylindrical portion 41 as seen in a plan view is accommodated in the cylindrical portion 41. As shown in FIG. 1, the supply table 42 has a shape of a flat plate. The supply table 42 is inserted into the cylindrical portion 41 generally horizontally. The supply table 42 is movable in the up-down direction in the cylindrical portion 41. A supply table elevator 43 is provided below the supply table 42. The supply table elevator 43 supports, and moves up and down, the supply table 42. In this preferred embodiment, the supply table elevator 43 supports the supply table 42 from below. The supply table elevator 43 includes a support portion 43a, a driving motor 43b, and a ball screw (not shown). The support portion 43a is connected with a bottom surface of the supply table 42. The support portion 43a is connected with the driving motor 43b via the ball screw. The driving motor 43b is driven, and as a result, the support portion 43a is moved in the up-down direction. The supply table 42 is supported by the support portion 43a, and moves in the up-down direction together with the support portion 43a. The driving motor 43b is electrically connected with the controller 100, and is controlled by the controller 100. The driving motor 43b is, for example, a servo motor, and is capable of controlling the height of the supply table 42.

As shown in FIG. 1, the printing tank 50 is provided to the front of the supply tank 40. The supply tank 40 and the printing tank 50 are provided side by side in the sub scanning direction X. The printing tank 50 is positionally aligned with the supply tank 40 in the main scanning direction Y. In the printing tank 50, the printing object 230 is printed of the powder material 200. The printing tank 50 includes a cylindrical portion 51 extending in the up-down direction. The cylindrical portion 51 includes an opening 51a (FIG. 2) opened upward. As shown in FIG. 2, the opening 51a is rectangular as seen in a plan view. The opening 51a is not limited to having a rectangular planar shape. As seen in a plan view, the opening 51a has a length in the main scanning direction Y equal to a length of the opening 41a of the supply tank 40 in the main scanning direction Y. Alternatively, the length of the opening 51a of the printing tank 50 in the main scanning direction Y may be shorter than the length of the opening 41a of the supply tank 40 in the main scanning direction Y.

A printing table 52 having the same shape as that of the cylindrical portion 51 as seen in a plan view is accommodated in the cylindrical portion 51. For printing the printing object 230, the powder material 200 is supplied onto the printing table 52, and the printing is performed on the printing table 52. As shown in FIG. 1, the printing table 52 has a shape of a flat plate. The printing table 52 is inserted into the cylindrical portion 51 generally horizontally. The printing table 52 is movable in the up-down direction in the cylindrical portion 51. A printing table elevator 53 is provided below the printing table 52. The printing table elevator 53 supports, and moves up and down, the printing table 52. In this preferred embodiment, the printing table elevator 53 supports the printing table 52 from below. The printing table elevator 53 includes a support portion 53a, a driving motor 53b, and a ball screw (not shown). The support portion 53a is connected with a bottom surface of the printing table 52. The support portion 53a is connected with the driving motor 53b via the ball screw. The driving motor 53b is driven, and as a result, the support portion 53a is moved in the up-down direction. The printing table 52 is supported by the support portion 53a, and moves in the up-down direction together with the support portion 53a. The driving motor 53b is electrically connected with the controller 100, and is controlled by the controller 100. The driving motor 53b is, for example, a servo motor, and is capable of controlling the height of the printing table 52.

The powder recovery tank 60 recovers a portion of the powder material 200 that is not accommodated in the printing tank 50 when the powder material 200 is spread in the printing tank 50 (hereinafter, this portion of the powder material 200 will be referred to also as “extra powder” and will be represented by reference sign 250). The powder recovery tank 60 is located to the front of the printing tank 50. The powder recovery tank 60 is provided side by side with the printing tank 50 and the supply tank 40 in the sub scanning direction X. The powder recovery tank 60 is positionally aligned with the printing tank 50 in the main scanning direction Y. The powder recovery tank 60 includes a cylindrical portion 61 extending in the up-down direction. The cylindrical portion 61 includes an opening 61a (FIG. 2) opened upward. As shown in FIG. 2, the opening 61a is rectangular as seen in a plan view. The opening 61a is not limited to having a rectangular planar shape. As seen in a plan view, the opening 61a has a length in the main scanning direction Y equal to the length of each of the opening 41a of the supply tank 40 and the opening 51a of the printing tank 50 in the main scanning direction Y. Alternatively, the length of the opening 61a of the powder recovery tank 60 in the main scanning direction Y may be longer than the length of the opening 51a of the printing tank 50 in the main scanning direction Y.

The cylindrical portion 61 is detachable from the printing tank unit 12. In this preferred embodiment, the cylindrical portion 61 is supported at a step 12b, which is one step below the top surface 12a of the printing tank unit 12. The cylindrical portion 61 is drawn out of the printing tank unit 12 by being pulled upward. The step 12b of the printing tank unit 12 is a support that supports the cylindrical portion 61 of the powder recovery tank 60 such that the cylindrical portion 61 is detachable.

A recovery table 62 having the same shape as that of the cylindrical portion 61 as seen in a plan view is accommodated in the cylindrical portion 61. The extra powder 250 is placed on the recovery table 62 and recovered. As shown in FIG. 1, the recovery table 62 has a shape of a flat plate. The recovery table 62 is inserted into the cylindrical portion 61 generally horizontally. The recovery table 62 is movable in the up-down direction in the cylindrical portion 61. A recovery table elevator 63 is provided below the recovery table 62. The recovery table elevator 63 supports, and moves up and down, the recovery table 62. In this preferred embodiment, the recovery table elevator 63 supports the recovery table 62 from below. The recovery table elevator 63 includes a support portion 63a, and the support portion 63a supports a bottom surface of the recovery table 62. In this preferred embodiment, the recovery table 62 and the support portion 63a are not secured to each other, and are separable from each other. For example, in the state shown in FIG. 1, the recovery table 62 is on the support portion 63a.

The recovery table elevator 63 further includes a driving motor 63b moving up and down the support portion 63a and a ball screw (not shown). The driving motor 63b is connected with the support portion 63a via the ball screw. The driving motor 63b is driven, and as a result, the support portion 63a is moved in the up-down direction. The recovery table 62 is on the support portion 63a and moves in the up-down direction together with the support portion 63a. The driving motor 63b is electrically connected with the controller 100, and is controlled by the controller 100. The driving motor 63b is, for example, a servo motor, and is capable of controlling the height of the recovery table 62.

As shown in FIG. 1, a stopper 61b is provided on an inner side surface of the cylindrical portion 61. The stopper 61b is a protrusion protruding inward in the cylindrical portion 61. The stopper 61b is provided below the recovery table 62. Thus, when moving down in the cylindrical portion 61, the recovery table 62 hits the stopper 61b. The recovery table 62 is not moved to a position lower than the position where the recovery table 62 hits the stopper 61b. With such a structure, when the support portion 63a of the recovery table elevator 63 is moved to a position lower than the position where the recovery table 62 hits the stopper 61b, the support portion 63a and the recovery table 62 are separated from each other. When the cylindrical portion 61 is pulled upward in this state, the recovery table 62 is detached from the printing tank unit 12 together with the cylindrical portion 61. In this manner, the recovery table 62 is detachable from the printing tank unit 12 together with the cylindrical portion 61 while being in the cylindrical portion 61.

The sub scanning direction conveyor 20 moves the printing tank unit 12 in the sub scanning direction X with respect to the head unit 70 and the roller unit 30. The sub scanning direction conveyor 20 includes a pair of guide rails 21 and a feed motor 22.

As shown in FIG. 1, the guide rails 21 (only one is shown in FIG. 1) guide the movement of the printing tank unit 12 in the sub scanning direction X. The guide rails 21 are provided in the main body 11. The guide rails 21 extend in the sub scanning direction X. The printing tank unit 12 is slidably in engagement with the guide rails 21. There is no specific limitation on the position(s) or the number of the guide rails 21. The feed motor 22 is, for example, connected with the printing tank unit 12 via a ball screw or the like. The feed motor 22 is electrically connected with the controller 100. The feed motor 22 is driven to rotate, and as a result, the printing tank unit 12 is moved in the sub scanning direction X on the guide rails 21.

The sub scanning direction conveyor 20 and the roller unit 30 are included in a layer former that flattens the powder material 200, supplied by the supply tank 40, in the printing tank 50. The roller unit 30 includes a spreading roller 30 and a pair of roller supports 32 supporting the spreading roller 31. The spreading roller 31 is an example of layer flattener that contacts the powder material 200 to flatten the powder material 200. The spreading roller 31 is located above the main body 11. The spreading roller 31 is located to the front of the head unit 70. The spreading roller 31 has an elongated cylindrical shape. The spreading roller 31 is located such that an axis thereof in a longitudinal direction thereof extends in the main scanning direction Y. The spreading roller 31 is longer than the printing tank 50 in the main scanning direction Y. A bottom end of the spreading roller 31 is slightly above the printing tank unit 12 so as to form a clearance (gap) between the bottom end of the spreading roller 31 and the top surface 12a of the printing tank unit 12. The spreading roller 31 is rotatably supported by the pair of roller supports 32 provided on a top surface 11a of the main body 11. The spreading roller 31 may be rotatable by, for example, a motor connected thereto.

When the printing tank unit 12 is moved rearward by the sub scanning direction conveyor 20, the spreading roller 31 moves forward with respect to the supply tank 40, the printing tank 50 and the powder recovery tank 60. At this point, the spreading roller 31 moves from above the supply tank 40 to above the printing tank 50 and further to above the powder recovery tank 60. A combination of the sub scanning direction conveyor 20 and the roller supports 32 is an example of conveyor that moves the spreading roller 31 as the layer flattener at least from above the printing tank 50 to above the powder recovery tank 60. The combination of the sub scanning direction conveyor 20 and the roller supports 32 as an example of conveyor moves the spreading roller 31 from above the supply tank 40 to above the powder recovery tank 60 while keeping the spreading roller 31 at a predetermined height above the supply tank 40, the printing tank 50 and the powder recovery tank 60.

As shown in FIG. 2, the head unit 70 includes a carriage 71 and a plurality of injection heads 72 mounted on the carriage 71. The plurality of injection heads 72 are located on a bottom surface of the carriage 71. The injection heads 72 inject a curing liquid toward the powder material 200 in the printing tank 50. As shown in FIG. 2, the plurality of injection heads 72 are located side by side in the main scanning direction Y. The injection heads 72 each include a plurality of nozzles 73, through which the curing liquid is injected. The plurality of nozzles 73 in each of the injection heads 72 are located linearly in the sub scanning direction X. There is no specific limitation on the mechanism that injects the curing liquid from the injection heads 72. For example, an inkjet mechanism is preferably usable. The injection heads 72 are electrically connected with the controller 100, and are controlled by the controller 100.

As the curing liquid, any liquid capable of bonding particles of the powder material 200 is usable with no specific limitation. As the curing liquid, a liquid (encompassing a viscous material) capable of bonding the particles of the powder material 200 is selected in accordance with the type of the powder material 200. The curing liquid may be, for example, a liquid containing water, wax, binder or the like. In the case where the powder material 200 contains a water-soluble resin as a sub material, the curing liquid may be a liquid capable of dissolving the water-soluble resin, for example, water. There is no specific limitation on the type of the water-soluble resin. Examples of the water-soluble resin include starch, polyvinyl alcohol (PVA), polyvinyl pyrrolidone (PVP), water-soluble acrylic resin, water-soluble urethane resin, water-soluble polyamide, and the like.

The main scanning direction conveyor 80 moves the carriage 71 in the main scanning direction Y. As shown in FIG. 2, the main scanning direction conveyor 80 includes a guide rail 81. The guide rail 81 extends in the main scanning direction Y. The carriage 71 is slidably in engagement with the guide rail 81. The carriage 71 is, for example, connected with a carriage motor 82 via, for example, an endless belt and a pulley. The carriage motor 82 is driven, and as a result, the carriage 71 moves in the main scanning direction Y along the guide rail 81. The carriage motor is electrically connected with the controller 100, and is controlled by the controller 100. The carriage 71 moves in the main scanning direction Y, and as a result, the plurality of injection heads 72 also move in the main scanning direction Y.

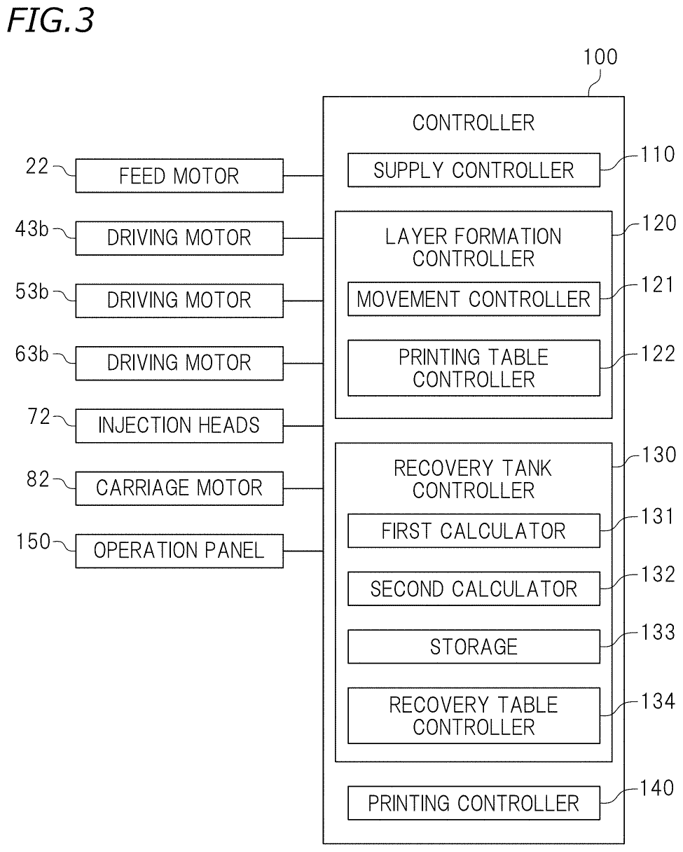

As shown in FIG. 1, an operation panel 150 is provided on a front surface of the main body 11. The operation panel 150 includes a display portion that displays states of devices, input keys that are operable by a user, and the like. The operation panel 150 is connected with the controller 100 controlling various operations of the three-dimensional printing device 10. FIG. 3 is a block diagram of the three-dimensional printing device 10 according to this preferred embodiment. As shown in FIG. 3, the controller 100 is electrically connected with the feed motor 22, the driving motor 43b of the supply table elevator 43, the driving motor 53b of the printing table elevator 53, the driving motor 63b of the recovery table elevator 63, the injection heads 72 and the carriage motor 82, and controls operations thereof.

As shown in FIG. 3, the controller 100 includes a supply controller 110, a layer formation controller 120, a recovery tank controller 130, and a printing controller 140. The controller 100 may include any other controller, which will not be described or shown herein.

There is no specific limitation on the structure of the controller 100. The controller 100 is, for example, a microcomputer. There is no specific limitation on the hardware structure of the microcomputer. For example, the controller 100 includes an interface (I/F) receiving printing data or the like from an external device such as a host computer or the like, a central processing unit (CPU) executing a command in a control program, a read only memory (ROM) storing the program to be executed by the CPU, a random access memory (RAM) usable as a working area in which the program is developed, and a storage, such as a memory or the like, storing the above-mentioned program, various data and the like. The controller 100 does not need to be provided in the three-dimensional printing device 10, and may be, for example, a computer or the like installed outside the three-dimensional printing device 10 and communicably connected with the three-dimensional printing device 10 in a wired or wireless manner.

The supply controller 110 controls the driving motor 43b of the supply tank 40 to supply the powder material 200. The supply controller 110 drives the driving motor 43b and thus moves up the supply table 42 to cause a top portion of the powder material 200 to spill over the cylindrical portion 41. The supply controller 110 supplies the powder material 200 by such a control. The supply controller 110 supplies a predefined amount of the powder material 200 each time. Specifically, the supply controller 110 moves up the supply table 42 by a predefined distance each time to supply the predefined amount of the powder material 200. The supply of the powder material 200 by the supply tank 40 will be described below in detail.

The layer formation controller 120 controls an operation of spreading the powder material 200 in the printing tank 50. The layer formation controller 120 includes a movement controller 121 and a printing table controller 122. The movement controller 121 controls the sub scanning conveyor 20 as the conveyor to move the spreading roller 31 with respect to the supply tank 40, the printing tank 50 and the powder recovery tank 60. In actuality, however, the printing tank unit 12 moves in the sub scanning direction X.

Prior to moving the spreading roller 31, the printing table controller 122 controls the printing table elevator 53 to move down the printing table 52 by a predetermined distance. In order to cause a predefined amount of the powder material 200 to remain on the printing table 52 each time the powder material 200 is supplied, the printing table controller 122 moves down the printing table 52 by a distance corresponding to the predefined amount. In other words, the powder material 200 remains on the printing table 52 in an amount corresponding to the distance by which the printing table controller 122 moves down the printing table 52, and the other portion of the powder material 200 is moved into the powder recovery tank 60. The distance by which the printing table controller 122 moves down the printing table 52 preferably is equal to a thickness of one cured layer 220, and is, for example, about 0.1 mm.

The recovery tank controller 130 controls an operation of the powder recovery tank 60. The recovery tank controller 130 includes a first calculator 131, a second calculator 132, a storage 133, and a recovery table controller 134.

The first calculator 131 calculates the amount of the powder material 200 to be moved onto the recovery table 62 by the sub scanning direction conveyor 20 and the roller unit 30. In more detail, the first calculator 131 subtracts the amount of the powder material 200 that remains on the printing table 52 each time the powder material 200 is supplied, from the amount of the powder material 200 supplied by the supply controller 110 each time. Then, the first calculator 131 finds the result of the subtraction as the amount of the powder material 200 to be moved onto the recovery table 62 each time the powder material 200 is supplied.

The second calculator 132 calculates the position of a top end of the powder material 200 in the state in which the powder material 200 of the amount calculated by the first calculator 131 is accumulated on the recovery table 62. In this preferred embodiment, the second calculator 132 performs the calculation with a setting that a value obtained by dividing the amount of the powder material 200 calculated by the first calculator 131 by a surface area size of the cylindrical portion 61 as seen in a plan view is the height of the powder material 200 accumulated on the recovery table 62. The second calculator 132 calculates the position of the top end of the powder material 200 based on the height of the powder material 200 accumulated on the recovery table 62 and the height of the recovery table 62 at that point. The powder material 200 is not accumulated on the recovery table 62 completely flat. Therefore, the position calculated by the second calculator 132 is slightly different from the position of a highest portion of the powder material 200 actually accumulated on the recovery table 62. In this preferred embodiment, such a difference is not considered to provide any specific problem. This will be described below.

The storage 133 stores an upper limit value and a lower limit value for a distance between the top end of the cylindrical portion 61 of the powder recovery tank 60 and the top end of the powder material 200 calculated by the second calculator 132. There is no specific limitation on the upper limit value or the lower limit value. The upper limit value is preferably set to, for example, about 30 mm or less, and is more preferably set to about 10 mm or less. The lower limit value is preferably set to, for example, more than 0 mm, and is more preferably set to about 2 mm or greater and about 5 mm or less. In this preferred embodiment, the upper limit value and the lower limit value are set to the same value. In other words, the storage 133 stores only one value as the distance between the top end of the cylindrical portion 61 of the powder recovery tank 60 and a top surface 250a of a layer of the extra powder 250.

The recovery table controller 134 controls the recovery table elevator 63 to move down the recovery table 62 such that the distance between the top end of the cylindrical portion 61 of the powder recovery tank 60 and the top end of the powder material 200 calculated by the second calculator 132 is between the upper limit value and the lower limit value inclusive stored on the storage 133. In this preferred embodiment, the recovery table controller 134 moves down the recovery table 62 each time the powder material 200 is supplied. The distance by which the recovery table 62 is moved down each time corresponds to the amount of the powder material 200 moved onto the recovery table 62 each time the powder material 200 is supplied, the amount being calculated by the first calculator 131. In other words, the distance is equal to the height by which the powder material 200 is accumulated on the recovery table 62 each time the powder material 200 is supplied, the height being calculated by the second calculator 132. By such a control, the distance between the top end of the cylindrical portion 61 of the powder recovery tank 60 and the top surface 250a of the layer of the extra powder 250 on the recovery table 62 is kept at a distance substantially equal to the set value stored on the storage 133. This control will be described below in detail.

The printing controller 140 controls an operation of curing a portion of the powder layer 210 to form the cured layer 220. The printing controller 140 controls the sub scanning direction conveyor 20, the injection heads 72 and the main scanning direction conveyor 80 to inject the curing liquid toward a desired position in the powder layer 210. The powder material 200 into which the curing liquid is injected is cured to form the cured layer 220.

Hereinafter, a process of printing the printing object 230 will be described. The process described below is merely a preferred example, and the process is not limited to the following process.

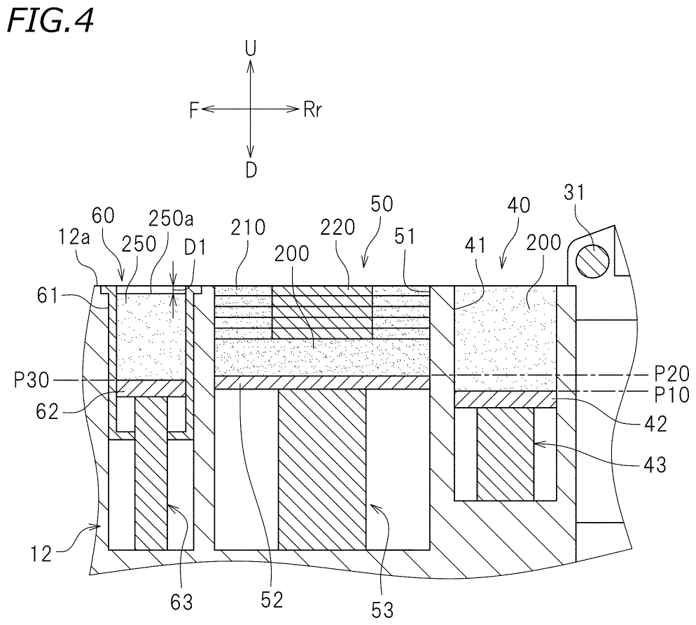

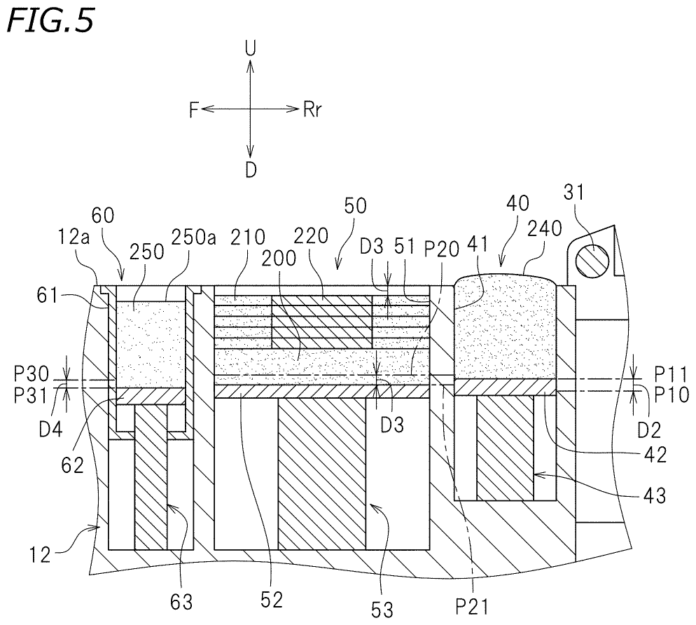

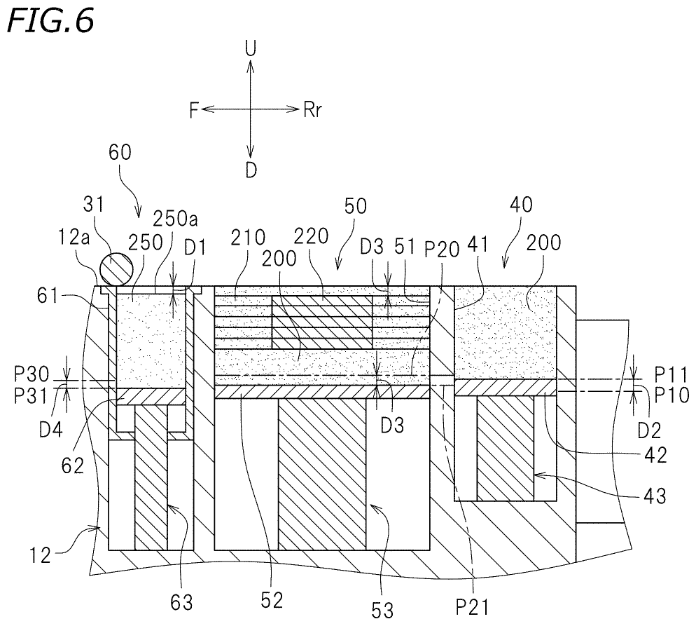

FIG. 4 through FIG. 6 are vertical cross-sectional views showing the printing tank unit 12 during the formation of the powder layer 210. Among these figures, FIG. 4 shows a state at the time when the formation of an immediately previous cured layer 220 is finished. FIG. 5 shows a state at the time when the powder material 200 is supplied from the supply tank 40. FIG. 6 shows a state after a new powder layer 210 is formed.

As shown in FIG. 4, at the time when the formation of the immediately previous cured layer 220 is finished, a top surface of the supply table 42 is at position P10. The powder material 200 is on the supply table 42. A top surface of the powder material 200 on the supply table 42 is at the same height as that of the bottom end of the spreading roller 31. This height is equal or substantially equal to the height of the top surface 12a of the printing tank unit 12.

At the time of FIG. 4, a top surface of the printing table 52 is at position P20. A plurality of powder layers 210 are formed on the printing table 52. A top surface of an uppermost powder layer 210 is at the same height as that of the bottom end of the spreading roller 31.

A top surface of the recovery table 62 is at position P30. The extra powder 250 is on the recovery table 62. The top surface 250a of the layer of the extra powder 250 is below the top end of the cylindrical portion 61 of the powder recovery tank 60 by distance D1. Distance D1 is equal to the set value stored on the storage 133. Distance D1 is, for example, about 10 mm.

When the powder material 200 is to be supplied from the state shown in FIG. 4, the supply table 42, the printing table 52 and the recovery table 62 are moved in the up-down direction. As shown in FIG. 5, at the time when the powder material 200 is supplied from the supply tank 40, the top surface of the supply table 42 is at position P11. Position P11 is set to be above position P10 by distance D2. The supply table 42 is moved up by distance D2 in order to move from position P10 to position P11.

As a result of the supply table 42 being moved up, the top portion of the powder material 200 spills over the supply tank 40. This portion of the powder material 200 that has spilt over the supply tank 40 is the powder material 200 to be supplied from the supply tank 40. Hereinafter, this portion of the powder material 200 that is to be supplied from, and that has been supplied from, the supply tank 40 will be referred to also as “supply powder 240”. The supply powder 240 has a volume obtained by multiplying moving distance D2 of the supply table 42 by a surface area size of the supply table 42 as seen in a plan view. Moving distance D2 and the surface area size of the supply table 42 as seen in a plan view are predefined. Therefore, the volume of the supply powder 240 is also predefined. Hereinafter, the volume of the supply powder 240 will be referred to as a “first volume V1”.

As shown in FIG. 5, the printing table 52 is moved down by distance D3 from the state shown in FIG. 4, and is at position P21. Distance D3 is equal to the thickness of the cured layer 220 to be formed next. When the powder material 200 is to be supplied, the printing table 52 is moved down by the thickness of one cured layer 220. Distance D3 is, for example, about 0.1 mm.

As a result of the printing table 52 moving down, the position of a top surface of the cured layer 220 is moved to a position that is below the bottom end of the spreading roller 31 by distance D3. The height of the bottom end of the spreading roller 31 is equal or substantially equal to the height of the top surface 12a of the printing tank unit 12. Therefore, as a result of the printing table 52 moving down, the top surface of the cured layer 220 is recessed from the top surface 12a of the printing tank unit 12 by a distance equal or substantially equal to distance D3.

In this preferred embodiment, as shown in FIG. 5, the recovery table 62 is also moved down by distance D4 from the state shown in FIG. 4, and is at position D31. The value of distance D4 will be described below.

From the state shown in FIG. 5, the three-dimensional printing device 10 moves the spreading roller 31 forward (in actuality, moves the printing tank unit 12 rearward), and moves the supply powder 240 spilling over the supply tank 40 into the printing tank 50 and the powder recovery tank 60. When the spreading roller 31 moves forward, a portion of the supply powder 240 over the supply tank 40 is spread in the printing tank 50 by the spreading roller 31. The volume of the above-mentioned portion of the supply powder 240 is equal to a volume obtained by multiplying distance D3 by which the printing table 52 has moved down by a surface area size of the printing table 52 as seen in a plan view. Hereinafter, this volume will be referred to as a “second volume V2”. The supply powder 240 that was not spread in the printing tank 50 is moved to the powder recovery tank 60 as the extra powder 250. The volume of the extra powder 250 recovered into the powder recovery tank 60 (this volume will be referred to as a “third volume V3”) is obtained by subtracting the second volume V2 from the first volume V1.

Distance D4 by which the recovery table 62 moves down from the state shown in FIG. 4 to the state shown in FIG. 5 is set to be equal or substantially equal to a distance by which the top surface 250a of the layer of the extra powder 250 is expected to be moved up by the extra powder 250 of the third volume V3 being placed on the recovery table 62. In more detail, distance D4 is set to be equal or substantially equal to a height obtained by dividing the third volume V3 by a surface area size of the recovery table 62 as seen in a plan view. Therefore, the height of the top surface 250a of the layer of the extra powder 250 in FIG. 6 is equal or substantially equal to the height of the top surface 250a of the layer of the extra powder 250 in FIG. 4 according to the calculation. Based on this, the top surface 250a of the layer of the extra powder 250 on the recovery table 62 is kept at the same height by performing the above-described operation each time the powder layer 210 is to be formed. Namely, the distance between the top end of the cylindrical portion 61 of the powder recovery tank 60 and the top surface 250a of the layer of the extra powder 250 at the time when the formation of the powder layer 210 is finished is kept equal or substantially equal to distance D1 shown in FIG. 4.

Distance D1 is stored on the storage 133, and is, for example, about 10 mm. In this preferred embodiment, the distance between the top end of the cylindrical portion 61 and the top surface 250a of the layer of the extra powder 250 at the time when the formation of the powder layer 210 is finished is kept at about 10 mm. At the height of about 10 mm, the extra powder 250, even when being dropped into the powder recovery tank 60, does not easily soar into the air or become airborne.

In the conventional three-dimensional printing device, the powder recovery tank has a bottom surface that is secured. Therefore, in order to allow a large amount of extra powder to be stored, the distance between the top end and the bottom surface of the powder recovery tank is long (e.g., 300 mm). However, the powder material, when being dropped into such a deep powder recovery tank, easily soars into the air and becomes airborne. If a large amount of powder material soars into the air and becomes airborne, a problem may be caused that, for example, the powder material is attached to the injection heads that inject the curing liquid, which prevents the injection heads from injecting the curing liquid properly.

Under such a situation, the powder recovery tank 60 according to this preferred embodiment includes the recovery table 62 movable up and down inside the cylindrical portion 61 and the recovery table conveyor 63 supporting, and moving up and down, the recovery table 62, and is capable of adjusting the distance between the top end of the cylindrical portion 61 and the top surface 250a of the layer of the extra powder 250 to a preferred distance. The present inventor has discovered that in the case where the distance between the top end of the cylindrical portion 61 and the top surface 250a of the layer of the extra powder 250 is short, for example, about 30 mm or less, the extra powder 250 does not easily soar into the air or become airborne. The three-dimensional printing device 10 having such a structure is capable of adjusting the distance between the top end of the cylindrical portion 61 and the top surface 250a of the layer of the extra powder 250 to a preferred distance as described above. Therefore, the amount of the extra powder 250 in the powder recovery tank 60 that soars into the air and becomes airborne is decreased.

The conventional three-dimensional printing device has a problem that in the case where a powder material that is a mixture of two or more of components (e.g., aggregate and binder) is used, the components may be separated from each other as a result of the powder material soaring into the air and become airborne. In the case where, for example, the powder material is a mixture of an aggregate and a binder and the particle diameter of the binder is shorter than the particle diameter of the aggregate, the binder soaring into the air lands after the aggregate soaring into the air. This causes the components to be separated from each other. When the components are separated from each other, the powder material recovered in the powder recovery tank needs to be re-stirred in order to be reused.

With the three-dimensional printing device 10 according to this preferred embodiment, the amount of the extra powder 250 soaring into the air and become airborne is small. Therefore, the amount of the components separated from each other is small. For this reason, the recovered powder material 200 does not need to be re-stirred much, or does not need to be re-stirred at all.

The three-dimensional printing device 10 according to this preferred embodiment calculates the amount of the extra powder 250 to be moved onto the recovery table 62 and calculates the height of the layer of the extra powder 250 in the powder recovery tank 60 based on the calculated amount. The three-dimensional printing device 10 according to this preferred embodiment adjusts the distance between the top surface 250a of the layer of the extra powder 250 and the top end of the cylindrical portion 61 of the powder recovery tank 60 to a value within a predetermined range. With such a structure, the height of the recovery table 62 is automatically adjusted to a preferred height.

The above-described automatic adjustment on the height of the recovery table 62 is easily realized by setting constant each of the first volume V1 of the supply powder 240 and the second volume V2 of the powder material 200 used to form the powder layer 210. The third volume V3 of the powder material 200 accumulated in the powder recovery tank 60 as the extra powder 250 is obtained by subtracting the second volume V2 from the first volume V1 and thus is known in advance. Therefore, the calculation of distance D4 by which the recovery table 62 is to be moved down is made easy.

According to this preferred embodiment, the adjustment on the height of the recovery table 62 is performed each time the powder material 200 is supplied. With such a control, the distance between the top surface 250a of the layer of the extra powder 250 and the top end of the cylindrical portion 61 of the powder recovery tank 60 is always the same at the time when the formation of the powder layer 210 is finished. Such a method merely requires the recovery table 62 to be moved down by distance D4, which is calculated in advance, each time the powder material 200 is supplied, and thus is easily performed.

As described above, the extra powder 250 is not accumulated on the recovery table 62 in a completely flat state. Therefore, the position of the top surface 250a of the layer of the extra powder 250 calculated by the second calculator 132 is slightly different from the position of a highest portion of the extra powder 250 actually accumulated on the recovery table 62. The position calculated by the second calculator 132 is the position of the top surface 250a of the layer of the extra powder 250 in the case where the extra powder 250 is accumulated on the recovery table 62 flat. However, the powder recovery tank 60 is to recover the extra powder 250 and is not directly related to the printing of the printing object 230. Therefore, it is not needed to adjust the position of the highest portion of the extra powder 250 accumulated on the recovery table 62 highly precisely. Distance D1 between the top surface 250a of the layer of the extra powder 250 and the top end of the cylindrical portion 61 of the powder recovery tank 60 merely needs to be kept at a distance by which the extra powder 250 does not spill over the powder recovery tank 60 and the extra powder 250 does not easily soar or become airborne, for example, at several millimeters to about 30 mm. Distance D1 does not need to be adjusted further or more precisely.

When the new powder layer 210 is formed on the cured layer 220 as described above, a new cured layer 220 is formed in the new powder layer 210. The three-dimensional printing device controls the feed motor 22, the injection heads 72 and the carriage motor 82 to inject the curing liquid toward a desired position in the powder layer 210. Thus, the new cured layer 220 is formed in the new powder layer 210.

When the printing of the printing object 230 is finished, the recovery table 62 is moved down until hitting the stopper 61b. As a result, the support portion 63a of the recovery table elevator 63 is separated from the recovery table 62. The recovery table 62 is supported by the stopper 61b. Thus, the recovery table 62, integral with the cylindrical portion 61, is detachable from the printing tank unit 12. The cylindrical portion 61 of the powder recovery tank 60 may be drawn out of the printing tank unit 12 by being pulled upward. In this manner, the extra powder 250 is recovered into the powder recovery tank 60 is separated from the printing tank unit 12 while being in the powder recovery tank 60.

With the above-described structure, the powder recovery tank 60 is detachable from the printing tank unit 12 while accommodating the extra powder 250. Thus, the extra powder 250 is recovered easily.

### Modification of Embodiment 1

Preferred embodiment 1 may be carried out in some modifications. For example, in preferred embodiment 1, the recovery table 62 is moved down each time the formation of the powder layer 210 is performed once. Alternatively, the recovery table 62 may be moved down each time the formation of the powder layer 210 is performed a plurality of times. In this modification, the storage 133 stores different values as the upper limit value and the lower limit value. The distance between the top surface 250a of the layer of the extra powder 250 and the top end of the cylindrical portion 61 of the powder recovery tank 60 fluctuates between the lower limit value and the upper limit value inclusive. For example, it is assumed that the upper limit value is set to about 10 mm and the lower limit value is set to about 5 mm. It is also assumed that the thickness of the layer of the extra powder 250 is increased by about 1 mm each time the formation of the powder layer 210 is performed once. In this case, when the distance between the top surface 250a of the layer of the extra powder 250 and the top end of the cylindrical portion 61 of the powder recovery tank 60 reaches the lower limit value, i.e., about 5 mm, the recovery table 62 is moved down by about 5 mm. As a result, the distance between the top surface 250a of the layer of the extra powder 250 and the top end of the cylindrical portion 61 of the powder recovery tank 60 becomes the upper limit, i.e., about 10 mm. After the formation of the layer 210 is performed five more times, the distance between the top surface 250a of the layer of the extra powder 250 and the top end of the cylindrical portion 61 of the powder recovery tank 60 becomes lower limit value, i.e., about 5 mm, again. In this modification, the recovery table 62 is moved down by about 5 mm each time the formation of the powder layer 210 is performed five times.

According to this modification, the recovery table 62 does not need to be moved down each time the formation of the powder layer 210 is performed once. This alleviates the deterioration of the components of the powder recovery tank 60 caused by the movement of the recovery table 62.

### Preferred Embodiment 2

A three-dimensional printing device according to preferred embodiment 2 includes a sensor that senses the height of extra powder in a powder recovery tank. A controller adjusts the height of a recovery table based on the sensing result of the sensor. The three-dimensional printing device according to preferred embodiment 2 is the same as the three-dimensional printing device 10 according to preferred embodiment 1 except for the above-described points. Thus, in the following description of preferred embodiment 2, the components common to those in preferred embodiment 1 will bear the identical reference signs thereto, and overlapping descriptions will be omitted or simplified.

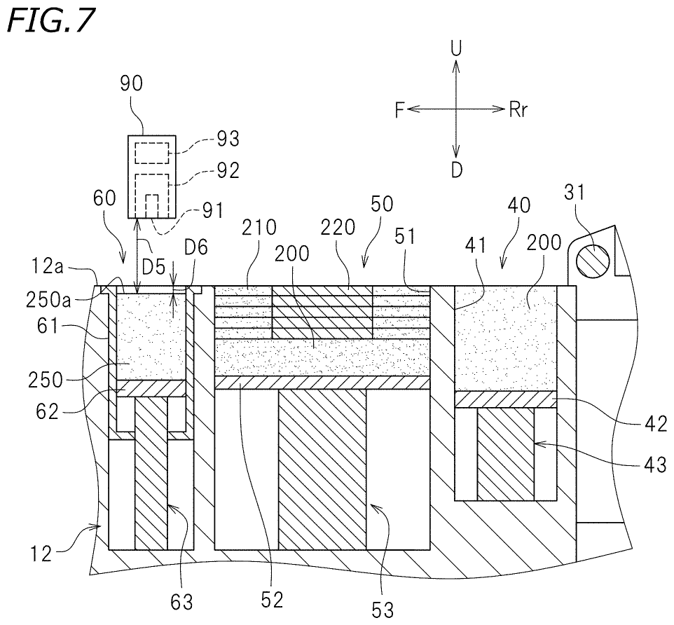

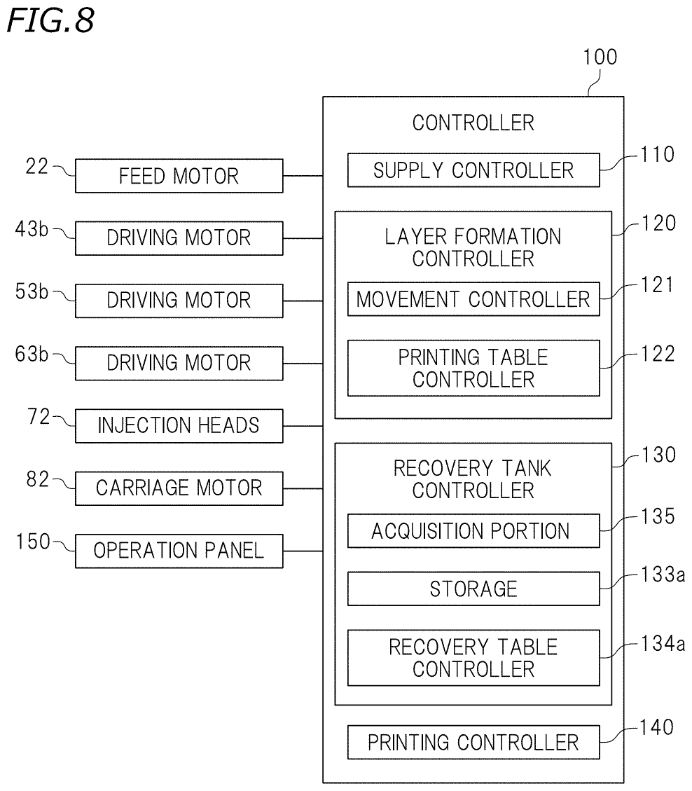

FIG. 7 is a vertical cross-sectional view of the printing tank unit 12 according to this preferred embodiment. FIG. 8 is a block diagram of the three-dimensional printing device 10 according to this preferred embodiment. As shown in FIG. 7, in this preferred embodiment, the three-dimensional printing device 10 includes an ultrasonic sensor 90 to sense the height of the extra powder 250 on the recovery table 62. The ultrasonic sensor 90 emits ultrasonic waves, and measures the distance between the ultrasonic sensor 90 and a target based on the time duration required for the reflected ultrasonic waves to return to the ultrasonic sensor 90.

As shown in FIG. 7, the ultrasonic sensor 90 is provided above the powder recovery tank 60. The ultrasonic sensor 90 includes an oscillator 91 to emit the ultrasonic waves, a sensor 92 to sense the ultrasonic waves reflected by an object, and a distance calculator 93 to determine the distance between the ultrasonic sensor 90 and the object based on the time duration required for the reflected ultrasonic waves to return to the ultrasonic sensor 90. The oscillator 91 emits the ultrasonic waves toward the recovery table 62 of the powder recovery tank 60 provided below the oscillator 91. The ultrasonic waves emitted by the oscillator 91 are reflected by the top surface 250a of the layer of the extra powder 250 on the recovery table 62. The reflected ultrasonic waves are sensed by the sensor 92. The distance calculator 93 calculates distance D5 between the ultrasonic sensor 90 and the top surface 250a of the layer of the extra powder 250 based on the difference between the time when the oscillator 91 oscillated the ultrasonic waves and the time when the sensor 92 sensed the reflected ultrasonic waves.

As shown in FIG. 8, the recovery tank controller 130 is configured or programmed to include an acquisition portion 135 to acquire the height of the extra powder 250 on the recovery table sensed by the ultrasonic sensor 90. In this preferred embodiment, the recovery tank controller 130 does not include the first calculator 131 or the second calculator 132. In this preferred embodiment, the distance between the top surface 250a of the layer of the extra powder 250 and the top end of the cylindrical portion 61 of the powder recovery tank 60 is not estimated but is actually measured by the ultrasonic sensor 90. The distance between the ultrasonic sensor 90 and the top end of the cylindrical portion 61 of the powder recovery tank 60 is known in advance. Therefore, distance D6 between the top end of the cylindrical portion 61 of the powder recovery tank 60 and the top surface 250a of the layer of the extra powder 250 on the recovery table 62 is found based on distance D5 sensed by the ultrasonic sensor 90.

A storage 133a according to this preferred embodiment stores an upper limit value and a lower limit value on distance D6. A recovery table controller 134a according to this preferred embodiment moves down the recovery table 62 such that distance D6 is between the upper limit value and the lower limit value inclusive stored on the storage 133a.

The three-dimensional printing device 10 having such a structure adjusts distance D6 between the top end of the cylindrical portion 61 of the powder recovery tank 60 and the top surface 250a of the layer of the extra powder 250 on the recovery table 62 to a preferred distance. In addition, the three-dimensional printing device 10 having such a structure finds distance D6 based on the actual measurement, and therefore, performs the control with more certainty.

Some preferred embodiments of the present invention have been described above. The above-described preferred embodiments are merely examples, and the present invention may be carried out in any of various other preferred embodiments.

For example, in the above-described preferred embodiments, the plurality of cured layers 220 all have the same thickness, and the amount of the supply powder 240 is the same all the times. Alternatively, all of the plurality of cured layers 220, or some of the plurality of cured layers 220 may have different thicknesses. The amount of the supply powder 240 may be different all the times, or may be different some of the times. Therefore, the amount of the extra powder 250 recovered into the powder recovery tank 60 may be different all the times or may be different some of the times.

In the above-described preferred embodiments, the powder supplier that supplies the powder material is the supply tank 40. The powder supplier is not limited to having the structure of the supply tank 40. For example, the powder supplier may drop the powder material from above to supply the powder material. There is no specific limitation on the structure of the powder supplier. The layer flattener that flattens the powder material to form the powder layer does not need to be the spreading roller 31, and may be, for example, a squeegee or the like. In the above-described preferred embodiments, the relative movement of the printing tank 50 and the spreading roller 31 is performed by the movement of the printing tank unit 12. The relative movement of the printing tank 50 and the spreading roller 31 is not limited to being performed in this manner. For example, the printing tank unit 12 may be secured to the main body 11, and the spreading roller 31 may be moved in the sub scanning direction X with respect to the printing tank unit 12. All the movements according to preferred embodiments of the present invention are relative movements, and which component is to be actually moved may be selected arbitrarily.

The preferred embodiments described herein do not limit the present invention unless otherwise specified.

The terms and expressions used herein are for description only and are not to be interpreted in a limited sense. These terms and expressions should be recognized as not excluding any equivalents to the elements shown and described herein and as allowing any modification encompassed in the scope of the claims. The present invention may be embodied in many various forms. This disclosure should be regarded as providing preferred embodiments of the principles of the present invention. These preferred embodiments are provided with the understanding that they are not intended to limit the present invention to the preferred embodiments described in the specification and/or shown in the drawings. The present invention is not limited to the preferred embodiments described herein. The present invention encompasses any of preferred embodiments including equivalent elements, modifications, deletions, combinations, improvements and/or alterations which can be recognized by a person of ordinary skill in the art based on the disclosure. The elements of each claim should be interpreted broadly based on the terms used in the claim, and should not be limited to any of the preferred embodiments described in this specification or referred to during the prosecution of the present application.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A three-dimensional printing device, comprising:
a powder supplier that supplies a powder material;
a printing tank in which a printing object is printed of the powder material;
a layer former that flattens the powder material, supplied by the powder supplier, in the printing tank; and
a powder recovery tank provided side by side with the printing tank; wherein
the layer former includes:
a layer flattener that contacts the powder material; and
a conveyor that moves the layer flattener at least from above the printing tank to above the powder recovery tank while keeping the layer flattener at a predetermined height above the printing tank and the powder recovery tank; and
the powder recovery tank includes:
a first cylindrical portion that is opened upward and extends in an up-down direction;
a first elevatable table that is accommodated in the first cylindrical portion and is movable up and down in the first cylindrical portion; and
a first elevator that supports, and moves up and down, the first elevatable table.

2. The three-dimensional printing device according to claim 1, further comprising a controller including:
a supply controller that controls the powder supplier to supply the powder material;
a movement controller that controls the conveyor to move the layer flattener;
a first calculator that calculates an amount of the powder material to be moved onto the first elevatable table by the layer former;
a second calculator that calculates a position of a top end of the powder material in a case where the powder material of the amount calculated by the first calculator is accumulated on the first elevatable table;
a storage that stores an upper limit value and a lower limit value for a distance between a top end of the first cylindrical portion and the top end of the powder material calculated by the second calculator; and
a first elevation controller that controls the first elevator to move down the first elevatable table such that the distance between the top end of the first cylindrical portion and the top end of the powder material calculated by the second calculator is between the upper limit value and the lower limit value inclusive stored in the storage.

3. The three-dimensional printing device according to claim 2, wherein the printing tank includes:
a second cylindrical portion that is opened upward and extends in the up-down direction;
a second elevatable table that is accommodated in the second cylindrical portion and is movable up and down in the second cylindrical portion; and
a second elevator that supports, and moves up and down, the second elevatable table;
the supply controller supplies the powder material of a predefined first amount each time;
the controller includes a second elevation controller that controls the second elevator to move down the second elevatable table by a distance corresponding to a predefined second amount such that the powder material of the predefined second amount remains on the second elevatable table each time the powder material is supplied; and
the first calculator calculates a third amount of the powder material obtained by subtracting the predefined second amount from the predefined first amount, as the amount of the powder material to be moved onto the first elevatable table each time the powder material is supplied.

4. The three-dimensional printing device according to claim 3, wherein the first elevation controller moves down the first elevatable table by a distance corresponding to the third amount each time the powder material is supplied.

5. The three-dimensional printing device according to claim 2, wherein the upper limit value is about 30 mm or less.

6. The three-dimensional printing device according to claim 1, further comprising:
a sensor to sense a height of the powder material on the first elevatable table; and
a controller is configured or programmed to include:
a supply controller that controls the powder supplier to supply the powder material;
a movement controller that controls the conveyor to move the layer flattener;
an acquisition portion that acquires the height of the powder material sensed by the sensor;
a storage that stores an upper limit value and a lower limit value for a distance between the top end of the first cylindrical portion and the top end of the powder material acquired by the acquisition portion; and
an elevation controller that controls the first elevator to move down the first elevatable table such that the distance between the top end of the first cylindrical portion and the top end of the powder material acquired by the acquisition portion is between the upper limit value and the lower limit value inclusive stored in the storage.

7. The three-dimensional printing device according to claim 6, wherein the sensor includes an ultrasonic sensor that emits ultrasonic waves and measures a distance between the ultrasonic sensor and a target based on a time duration required for reflected ultrasonic waves to return to the ultrasonic sensor.

8. The three-dimensional printing device according to claim 1, further comprising a support that supports the first cylindrical portion such that the first cylindrical portion is detachable; wherein
the first elevatable table is detachable together with the first cylindrical portion while being in the first cylindrical portion.
